(19) United States
(12) Patent Application Publication
(10) Pub. No.: US 2025/0277586 A1
(43) Pub. Date: Sep. 4, 2025

(54) REFRACTORY INSERT FOR COOKING APPARATUS

(71) Applicant: Premier Specialty Brands LLC, Chamblee, GA (US)

(72) Inventor: Klaus Xiao, Guangzhou City (CN)

(73) Assignee: Premier Specialty Brands LLC, Chamblee, GA (US)

(21) Appl. No.: 18/641,778

(22) Filed: Apr. 22, 2024

(30) Foreign Application Priority Data
Mar. 4, 2024 (CN) 202420411631.1

(51) Int. Cl. F24B 5/02

(52) U.S. Cl. CPC F24B 5/02

(57) ABSTRACT

Embodiments of the present disclosure are directed to an improved refractory insert that decreases fuel bridging within a fuel burning area. The refractory insert may be used for instance in any apparatus, system, or device where fuel is burned, including a cooking apparatus. In an embodiment, the improved refractory insert is comprised of two or more pieces of refractory material of varying heights. In some embodiments, one or more of the top edges of the refractory insert are sloped. The height variations and/or sloping of the top edges of the refractory insert help to significantly reduce bridging of fuel over the refractory insert.

### CROSS-REFERENCE TO RELATED APPLICATION

The present application claims the benefit of priority under 35 U.S.C. § 365(a-c) and 35 U.S.C. § 119(a) to Chinese Patent Application for Utility Model No. 202420411631.1, titled “Refractory Insert for Grill and Smoker,” filed Mar. 4, 2024 by Klaus Xiao, with the China National Intellectual Property Administration, which is hereby incorporated by reference in its entirety as if fully set forth herein.

### TECHNICAL FIELD

The presently disclosed technology generally relates to refractory inserts for use in apparatuses, systems, and devices where fuel is heated, such as a cooking apparatus, and more particularly, to improved refractory inserts that reduce the effects of bridging of fuel over the insert when used with an apparatus, system, and device where fuel is heated.

### BACKGROUND

Refractory materials are often used in systems and applications involving extreme mechanical, chemical, or thermal stresses. For instance, these types of materials are particularly useful in wood-fired kilns, fireplaces, ovens, grills, and smokers because they can withstand high temperatures and maintain dimensional stability, thereby providing greater energy efficiency as compared with non-refractory materials. Modern refractory materials used in grills and smokers are often composed of ceramics and/or ceramic composites and generally may be referred to as “fire brick” or “fireclay brick.”

For example, refractory materials used within the interior of barbecue grills and smokers allows the grill/smoker to withstand high heat and maintain greater energy efficiency during a cooking process. For example, one or more refractory materials may be positioned inside a high temperature area, such as a cooking enclosure and/or firebox, within a grill or smoker to absorb and reflect heat so as to reduce heat loss during the cooking process. One example of a barbecue grill and smoker that may use refractory fire brick materials is disclosed in U.S. Pat. No. 11,172,688 titled “Gravity Fed Smoker,” which is hereby incorporated by reference in its entirety as though fully set forth herein. In that patent, a refractory material (e.g., fire brick) is used to line certain interior surfaces within a firebox positioned underneath a feed hopper.

The feed hopper in the above-referenced patent is configured to contain various fuel types (e.g., charcoal, lump charcoal, wood) and allow the fuel to continuously fall vertically into the firebox, and thus is fed to the firebox using gravity. Once within the firebox, the fuel is ignited and combusted to generate heat and/or smoke for a cooking process. When larger pieces of fuel are fed from the feed hopper to the firebox, such as large pieces of wood or lump charcoal, one or more of the pieces of fuel inside the hopper may block the continuous gravity feeding of fuel into the firebox if they happen to fall upon the top edges of the fire bricks inside firebox, thus forming a “bridge” over the firebox that blocks or impedes the movement of fuel from the feed hopper into the firebox. This phenomenon is referred to as “bridging” throughout this disclosure. More generally, bridging may occur when one or more pieces of fuel become balanced or otherwise positioned on or over the top surfaces of refractory materials in a grill or smoker and thus span an area that prevents or impedes the introduction of additional fuel into a combustion region of the grill or smoker, such as a firebox. Such bridging of fuel on or over the firebox can impact the grill's ability to feed the fuel into the firebox from above, which in turn can cause tremendous variations in temperature and affect the grill's ability to both maintain a stable temperature during a cooking process and burn fuel efficiently.

The exemplary embodiments described herein of the presently disclosed technology are directed to these and other considerations and improvements.

### SUMMARY

An example embodiment of the presently disclosed technology comprises a refractory insert. The refractory insert may generally comprise a first set of opposing walls including at least a first wall and a second wall that are separated from each other, such as being positioned substantially across from each other or offset from each other at an angle where at least one inner surface of each wall at least partially faces an inner surface of the other wall.

In some embodiments, the first wall of the first set of opposing walls comprises a first height, and the second wall comprises a second height. The heights of the first and second walls can be measured vertically, e.g., from top to bottom or bottom to top, at any position along the length of each wall, for example, along an outer side edge of the wall, along another outer side edge of the wall, or along a vertical midline of the wall. Preferably the heights are measured vertically from the same relative point (or outer edge) along the length of each of the walls. Alternatively, the first and second heights can refer to the general position of the first and second walls with respect to a reference location within the grill or smoker. For example, in such embodiments, the first wall may be a different height than the height of the second wall because a top (or bottom) edge of the first wall is positioned higher within the grill or smoker than a top (or bottom) edge of the second wall, regardless of the shapes or sizes of the individual first and second walls.

Additionally, as described and shown herein, the height of the first wall of the first set of opposing walls can be different from the height of the second wall of the first set of opposing walls. For example, and not limitation, the height of the first wall can be greater than the height of the second wall. In other exemplary embodiments, the first and second heights of the first and second walls may be the same height or substantially the same height.

In some embodiments, the refractory insert also may comprise a second set of opposing side walls. In such embodiments, the side walls in the first and second sets of opposing side walls can be configured to line the inside of a rectangular-shaped area where fuel is burned or line at least a portion of the inside surfaces of any other enclosed area at or around where fuel is burned in a grill or smoker. A first wall of the second set of opposing walls can comprise a third height, and a second wall of the second set of opposing walls can comprise a fourth height. In some embodiments, the third height may be different from the fourth height. For example, and not limitation, the third height can be greater than the fourth height. Additionally, with respect to the first and second heights of the first set of opposing walls, one or both of the third and fourth heights of the second set of opposing walls can be greater or lesser than one or more of the first and second heights of the first set of opposing walls depending on the desired design or application for the refractory insert.

Additionally, in some exemplary embodiments, a top edge of at least one of the first and second walls of the first set of opposing walls can be sloped (angled). For instance, in some examples, the top edge of at least one of the first and second walls of the first set of opposing walls can be sloped at an angle between around 5 degrees to around 20 degrees in either direction relative to a horizontal axis (or other reference axis). In one example embodiment, the angle of the top edge of one or both of the first and second walls of the first set of opposing walls can be between 8 degrees to 9 degrees.

A top edge of at least one of the first and second walls of the second set of opposing walls can also be sloped. For instance, in some embodiments, the top edge of the at least one of the first and second walls of the second set of opposing walls can be sloped at an angle between around 5 degrees to around 20 degrees in either direction relative to a horizontal axis (or other reference axis). In an example embodiment, the angle of the top edge of one or both of the first and second walls of the second set of opposing walls can be from 8 degrees to 9 degrees.

A person having skill in the relevant art would understand that top edges of the walls of the refractory insert can have the same or different angles depending on the desired design or application for the refractory insert. In accordance with the disclosed embodiments, at least one of (i) the first and second heights or (ii) the slope angles of the top surfaces of the first and second walls in the first set of opposing walls are different. Similarly, in disclosed embodiments comprising a second set of opposing walls, at least one of (i) the third and fourth heights or (ii) the slope angles of the top surfaces of the first and second walls in the second set of opposing walls are different.

In some exemplary embodiments, the first set of opposing walls can be directly or indirectly coupled with the second set of opposing walls in the refractor insert. For instance, in some examples, the first set of opposing walls and the second set of opposing walls can be coupled together using brackets and fasteners, for example, positioned on or near corners of adjacent walls in the refractory insert. In some embodiments, for example, the brackets and fasteners may be used to couple adjacent side walls of the first and second sets of opposing walls to form a generally square, rectangular, rhombus, or trapezoidal shaped refractory insert that may be configured to be placed in contact with or in close proximity so as to line at least a portion of an interior enclosure (such as a feed hopper or other enclosure) of a grill or smoker. Those skilled in the art will appreciate that brackets and fasteners, placed at one or more corners of each adjacent side wall, are one exemplary mechanism for connecting the adjacent side walls in the disclosed embodiments and that other fastening, securing, or connecting mechanisms alternatively could be used without loss of generality regarding the disclosed technology herein.

An alternative embodiment of the presently disclosed technology comprises a cooking apparatus, such as a grill and smoker, wherein the cooking apparatus comprises a fuel-combusting area and a refractory insert positioned within the fuel-combusting area. The refractory insert can comprise at least one of a first set of opposing walls and a second set of opposing walls as described previously. In some embodiments, each set of opposing walls can be flush with an internal surface of the fuel-combusting area or another enclosed area of cooking apparatus, such as but not limited to a feed hopper. In an alternative embodiment, one or more of the opposing walls can be connected to an internal surface of the f a fuel-combusting area. In some disclosed embodiments, the first and second sets of opposing walls can line the internal surface of the fuel-combusting area.

### BRIEF DESCRIPTION OF THE DRAWINGS

The particular features and advantages of the disclosed technology will become apparent from the following description taken in connection with the accompanying drawings in which like reference numbers indicate identical or functionally similar elements. The following figures depict details of disclosed embodiments. The disclosed technology is not limited to the precise arrangement shown in these figures, as the accompanying drawings are provided merely as examples:

FIG. 1A is a perspective view of a grill and smoker, in accordance with an example embodiment of the presently disclosed technology.

FIG. 1B is a side view of a grill and smoker, in accordance with an example embodiment of the presently disclosed technology.

FIG. 1C is a cross-sectional view of a grill and smoker, in accordance with an example embodiment of the presently disclosed technology.

FIG. 2 is a perspective view of a prior art refractory insert.

FIGS. 3A-3C are various views of a refractory insert, in accordance with an example embodiment of the presently disclosed technology.

FIG. 4A-4I show various views of a refractory insert shown positioned relative to a feed hopper of a grill and smoker (such as that shown in FIGS. 1A-1C), in accordance with an example embodiment of the presently disclosed technology.

FIG. 5A-5C show various cross-sectional views of a refractory insert positioned within a grill and smoker (such as that shown in FIGS. 1A-1C), in accordance with an example embodiment of the presently disclosed technology.

FIG. 6A is a graphical representation of temperature (in degrees Fahrenheit) measured over time (in seconds) for several locations within the cooking chamber of a grill using a prior art refractory insert (such as that shown in FIG. 2).

FIG. 6B is a graphical representation of temperature (in degrees Fahrenheit) measured over time for several locations within the cooking chamber of a grill using an improved refractory insert (such as that shown in FIGS. 3A-3C).

### DETAILED DESCRIPTION OF THE DISCLOSED EMBODIMENTS

The example embodiments below address the above-mentioned problem of “bridging” that can occur when using a refractory insert in an apparatus, system, or device where fuel is burned. These example embodiments illustrate the use of a refractory insert in the context of an exemplary grill and smoker; however, it is understood that the benefits of the refractory inserts described herein are applicable to any apparatuses, systems, and methods where fuel is heated, including but not limited to, grills, smokers, ovens, kilns, fireplaces, and other types of cooking apparatuses and combinations thereof. The disclosed refractory inserts have an improved geometry that can facilitate fuel movement into and/or within a firebox by minimizing the effects of fuel becoming trapped due to bridging on or over the refractory insert. Advantageously, because the disclosed technology helps prevent such blockages and obstructions to fuel movement into the firebox, it does not suffer from variations in temperature during burning fuel and decreased fuel burn efficiency that would otherwise result from bridging effects. In other words, the improved geometry of the described refractory inserts can decrease variations in temperature during fuel burning and increase fuel burn efficiency.

In an example and non-limiting embodiment, a refractory insert can comprise an improved configuration or geometry of walls composed of fire brick for use in a grill and smoker or other cooking apparatus. Advantageously, the improved configuration of fire bricks can reduce or eliminate bridging of fuel pieces that would otherwise impede or block the movement of fuel into or through a firebox depending on where the bridging occurs. In some embodiments, the refractory insert can be positioned within or near the internal walls of a cooking enclosure and/or firebox of the grill and smoker. The refractory insert may comprise a collection of one or more fire brick pieces that can be separately positioned within the cooking enclosure or firebox or, alternatively, may be integrated into a single removable unit that can be placed within and removed from the cooking enclosure or firebox.

In some disclosed embodiments, individual walls (e.g., fire bricks) within the refractory insert can be separately removed and/or replaced. Further, in some disclosed embodiments, the refractory insert may be a single unit that can be positioned within and removed from a designated location within the interior of the grill and smoker. In such embodiments, the refractory insert may comprise one or more supporting structures on which the one or more bricks may be mounted. In other embodiments, supporting structure(s) for the one or more bricks of the refractory insert may be located within, or integrated into, a cooking enclosure or firebox of a grill or smoker.

As used throughout this disclosure, the terms “grill” or “smoker” each generally refer to any grill, smoker, kiln, fireplace, oven, or other cooking apparatus, or combinations thereof, that may be used to cook one or more food items using heat and/or smoke. Additionally, while the application refers generally to “grills” and “smokers” it is understood that the refractory inserts described herein may have other applications including but not limited to in apparatuses, systems, and methods where fuel is heated.

As used throughout this disclosure, the term “refractory inert” generally refers to any type of insert that can withstand high temperatures and maintain dimensional stability. For instance, the term “refractory” can refer to the type of material composition of the insert and can include any materials that can withstand high temperatures and maintain dimensional stability now known or later discovered, such as ceramics, ceramic composites, and metals. Alternatively, the term “refractory” can refer to any design that can withstand high temperatures and maintain dimensional stability, now known or later discovered. For instance, one or more of the walls of the refractory insert may be comprise a liner composed of a refractory material and a substance that provides insulating properties, such as air or ceramic, provided within the refractory liner. Additionally, in some embodiments, the refractory insert 300 may be composed of one or more pieces of fire brick. In other embodiments, the refractory insert may be composed of ceramic or other refractory materials, currently known or later discovered.

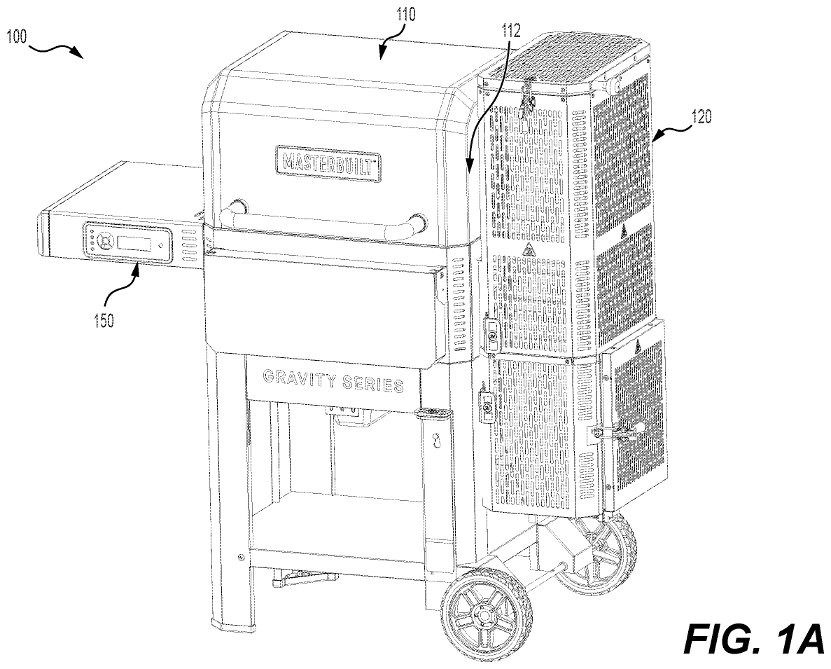

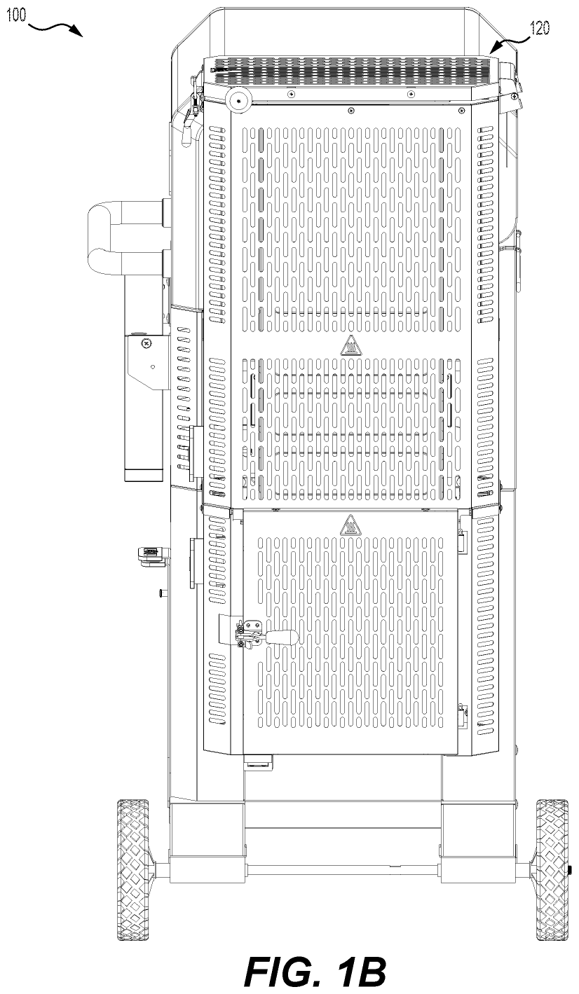

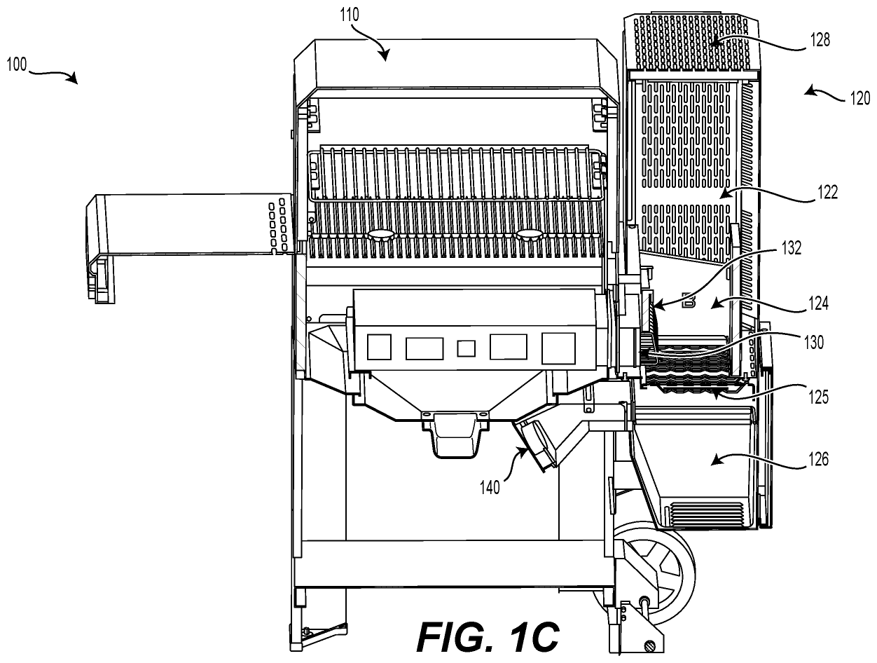

FIGS. 1A-1C illustrate an example grill and smoker 100 in which a refractory insert may be used in accordance with a certain exemplary embodiment of the present disclosure. The grill and smoker 100 comprises a food cooking enclosure 110 and an external stack 120. The external stack 120 may be connected to a side wall 112 of the food cooking enclosure 110 and may be generally rectangular in shape. As illustrated in FIG. 1C, the external stack 120 may include a feed hopper 122 for receiving fuel through a top opening 128, a firebox 124 for receiving fuel from the feed hopper 122 and burning the fuel during cooking, and a lower stack portion 126, comprising an ash removal bin (not shown). In some disclosed embodiments, a fan 140 may be configured to force air into the firebox 124 from an opening below a fire grate 125 within the firebox 124. Additionally, in some disclosed embodiments, a speed of the fan 140 can be controlled by a digital controller 150 (illustrated in FIG. 1A) that is configured to monitor a temperature within the food cooking enclosure 110 and adjust the speed of the fan 140 to maintain, increase, or decrease the temperature within the food cooking enclosure 110 based on one or more user-selected preferences (including, for instance, a temperature setting).

In the example grill and smoker illustrated in of FIGS. 1A-1C, the feed hopper 122 is located near the top of the stack 120 and is configured to receive solid fuel, such as charcoal, lump charcoal, and/or wood fed through a top opening 128. The feed hopper 122 is also positioned above and connected to the top of the firebox 124. The firebox 124 comprises a fire grate 125 on which the fuel can rest and combust when lit. In some embodiments, ashes generated from the spent fuel may fall through the fuel grate 125 and into an ash collector (not shown) positioned in lower stack portion 126. The firebox 124 includes a smoke outlet 130 which is substantially aligned with an inlet opening on the side 112 of the food cooking enclosure 110, such that heat and smoke generated in the firebox 124 may flow through the firebox's smoke outlet 130, through the inlet on the side 112, and into the food cooking enclosure 110. In some embodiments, the smoke outlet 130 may be covered by a smoke outlet grate 132 and/or spark arrester.

The grill and smoker shown in FIGS. 1A-1C may have one or more of the features of the grill and smoker described in U.S. Pat. No. 11,172,688 titled “Gravity Fed Smoker,” which is hereby incorporated by reference in its entirety as though fully set forth herein.

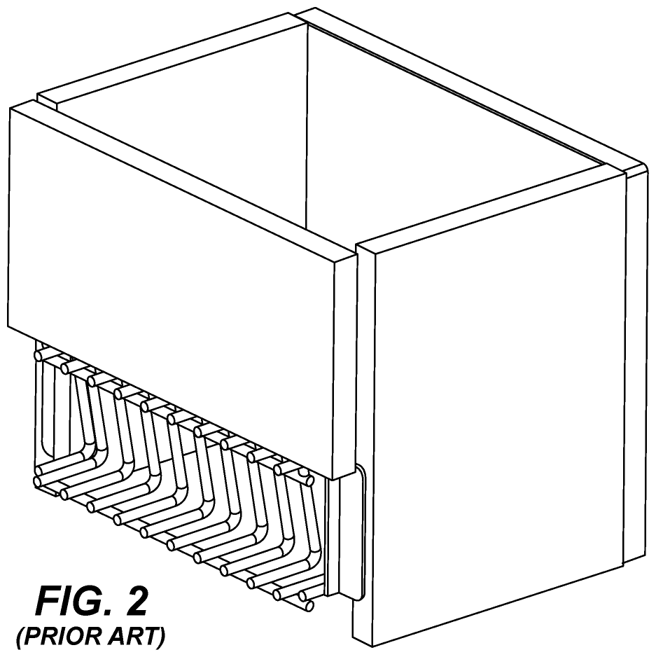

FIG. 2 illustrates a prior-art refractory insert that may be used, for instance, in a grill and smoker, such as that disclosed in FIGS. 1A-1C. As FIG. 2 shows, the prior-art refractory insert comprises four walls comprised of a refractory material, such as fire brick. The horizontal top edges of each wall in the insert are configured to be located at the same height and substantially coplanar with each other. The example prior-art refractory insert in FIG. 2 is configured for positioning within the firebox 124 of the grill and smoker 100 (e.g., firebox 124 in FIGS. 1A-1C). Each of the four walls of refractory fire-brick material line respective interior walls inside the firebox 124. The example prior-art refractory insert in FIG. 2 is composed of three side walls of approximately the same height (e.g., 200 mm), and one wall that is shorter (e.g., 111 mm) so that it can be positioned on or above a smoke outlet grate that allows smoke and heat to flow from the firebox 124 into the food cooking enclosure 110 when in use. Because the horizontal top edges of the four walls of the prior-art refractory insert are substantially in line with each other, the prior-art refractory insert is at a greater risk of causing bridging where one or more pieces of fuel may span from one wall's top surface to the top surface of another wall over the firebox 124, resulting in undesired and unpredictable temperature variability and decreased fuel efficiency.

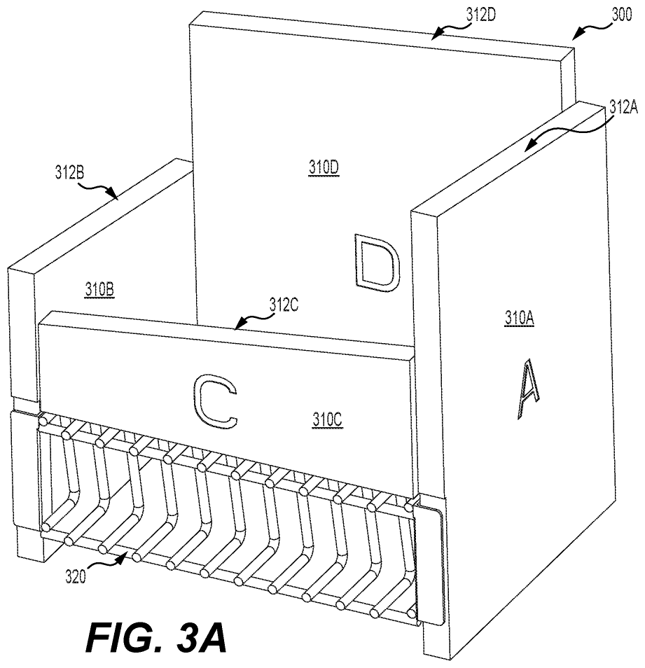

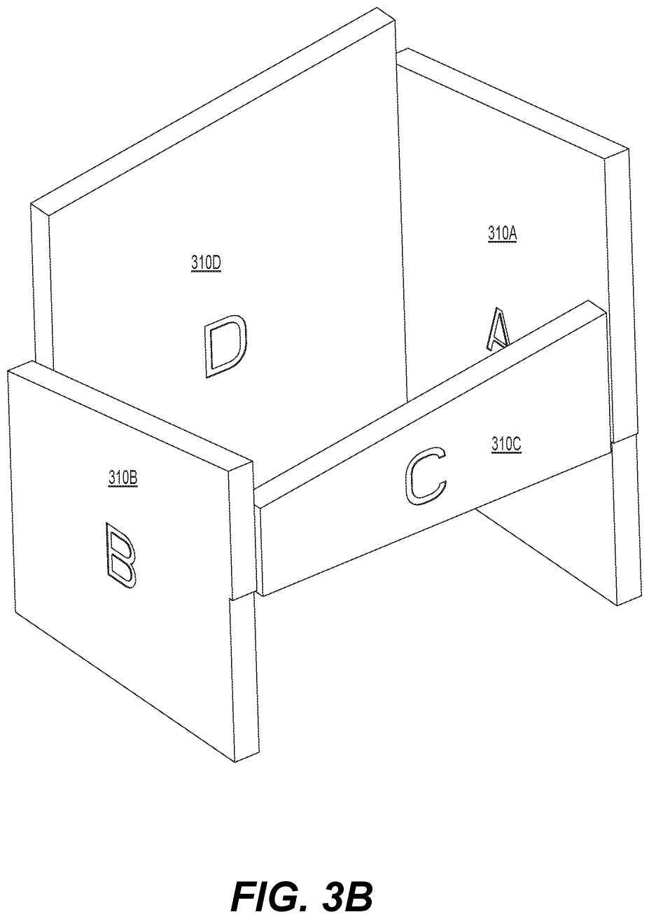

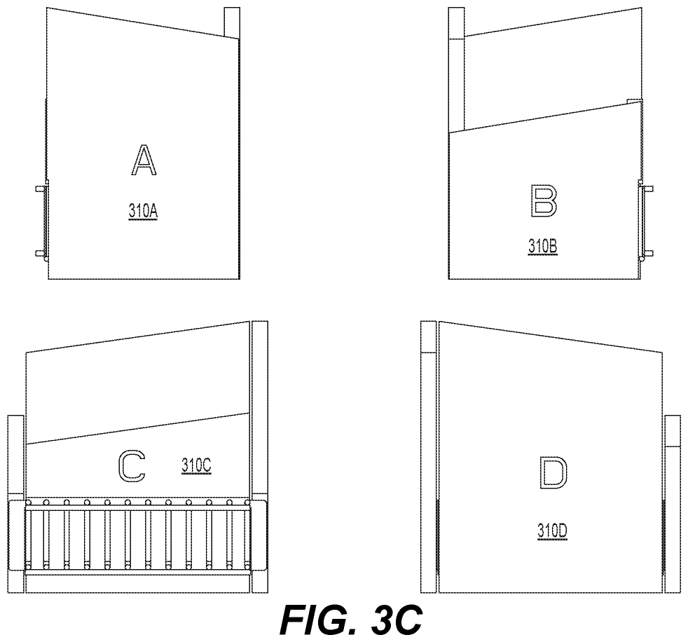

FIGS. 3A-3C illustrate an improved refractory insert 300 in accordance with an example embodiment of the presently disclosed technology. Refractory insert 300 may be used, for instance, in the grill and smoker 100 shown in FIGS. 1A-1C. The refractory insert 300 comprises four walls (310A, 310B, 310C, and 310D) of varying heights. In some disclosed embodiments, the refractory insert 300 comprises two or more walls having different heights when they are inserted into a firebox or food cooking enclosure. Unlike the prior-art refractory insert shown in FIG. 2, the top edges (312A, 312B, 312C and 312D) of the four walls (310A, 310B, 310C, and 310D) of the refractory insert 300 of the presently disclosed embodiments are not substantially at the same height and are not coplanar, with some walls extending higher than others. One or more of the four walls 310A, 310B, 310C, and 310D may also have a top edge that is sloped such as, for example, shown in FIG. 3A-3C. In the example embodiment of FIG. 3A and 3B, the wall 310D may have the greatest height, the wall 310A may have the second greatest height, the wall 310B may have the third greatest height, and the wall 310C may have the fourth greatest height. Those skilled in the art will appreciate that the relative heights of the walls 310A, 310B, 310C, and 310D of the refractory insert 300 may be configured differently in other disclosed embodiments, provided that at least two of the walls have different heights within the firebox 124 when the refractory insert 300 is positioned within the firebox 124 in this example. For example, at least two walls located at substantially opposite positions in the refractory insert 300, such as the pair of walls 310A and 310B or the pair of walls 310C and 310D, may have different heights when positioned in the firebox 124. For instance, one or more of the walls 310A, 310B, 310C, and 310D may be geometrically different (as shown in FIGS. 3A-3C) such that they have different heights with respect to one another. Alternatively, one or more of the walls 310A, 310B, 310C, and 310D may be geometrically similar (e.g. individually have the same height) but positioned at a different height within the firebox 124 such that one or more of the top edges (312A, 312B, 312C, or 312D) may be higher or lower within the firebox with respect to each other.

In the example embodiment of FIG. 3A, the shortest wall 310C can be mounted on, or otherwise coupled to, an exemplary smoke grate 322, which in some embodiments may be an angled smoke grate, through which heat and smoke may exit the firebox 124 through a smoke outlet 320 and enter the food cooking enclosure 110 in the exemplary grill and smoker 100 of FIGS. 1A-1C.

As shown in FIG. 3C, at least some of the top edges (312A, 312B, 312C and 312D) of the four walls (310A, 310B, 310C, and 310D) of the refractory insert 300 may be sloped with respect to the vertical side edges of the walls. Those skilled in the art will appreciate that in some embodiments, any one or more of the top edges 312A, 312B, 312C, and 312D may be sloped (e.g., angled) consistent with the disclosed embodiments of the refractory insert 300 described herein. In some embodiments, for example, each of the top edges of the four walls may be sloped at the same angle. In other embodiments, one or more of the top edges of the four walls can be sloped at different angles as compared with the sloped angles of the other top edges of the four walls. The angles of the slope of one or more of the top edges can be in the range of approximately 5 to 80 degrees, and specifically, in the range of 5 to 10 degrees, 10 to 15 degrees, 15 to 20 degrees, 20 to 25 degrees, 25 to 30 degrees, 30 to 35 degrees, 35 to 40 degrees, 40 to 45 degrees, 45 to 50 degrees, 50 to 55 degrees, 55 to 60 degrees, 60 to 65 degrees, 65 to 70 degrees, 70 to 75 degrees, and 75 to 80 degrees. In some embodiments the angle of the slope of one or more of the top edges can be at least 5 degrees, at least 10 degrees, at least 15 degrees, at least 20 degrees, at least 25 degrees, at least 30 degrees, at least 35 degrees, at least 40 degrees, at least 45 degrees, at least 50 degrees, at least 55 degrees, at least 60 degrees, at least 65 degrees, at least 70 degrees, and at least 75 degrees. In an example embodiment, the angle of each of the top edges of the walls is in the range of around 7 to 10 degrees, preferably around 8 to 9 degrees.

In an example embodiment, the relative dimensions of each of the walls (310A, 310B, 310C, and 310D) of the refractory insert 300 may be as follows:
Wall A (310A): side vertical walls having a height of 260 mm and 230 mm and a bottom horizontal wall having a length of 187 mm;
Wall B (310B): side vertical walls having a height of 140 mm and 170 mm and a bottom horizontal wall having a length of 187 mm.
Wall C (310C): side vertical walls having a height of 51 mm and 81 mm and a bottom horizontal wall having a length of 212 mm;
Wall D (310D): side vertical walls having a height of 260 mm and 230 mm and a bottom horizontal wall having a length of 215 mm.

It is understood that the relative dimensions of each of the walls (310A, 310B, 310C, and 310D) can be adjusted as desired based on, for instance, how the refractory insert 300 is used (e.g., in a grill, smoker, fireplace, kiln, oven, or other cooking apparatus), the relative dimensions of the area in which the refractory insert is used, and other components located around and/or adjacent to the refractory insert 300 (e.g., side grate 320 or fire grate 125).

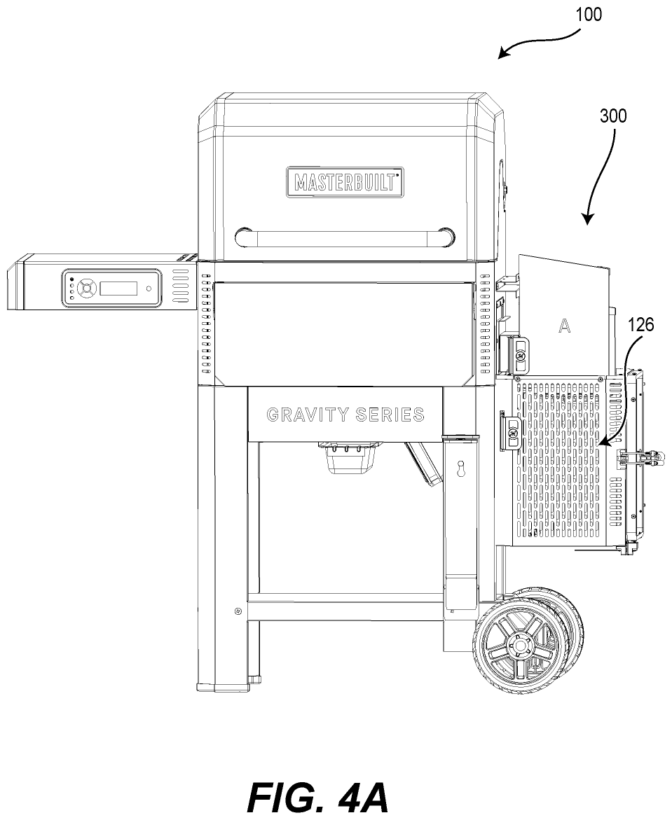

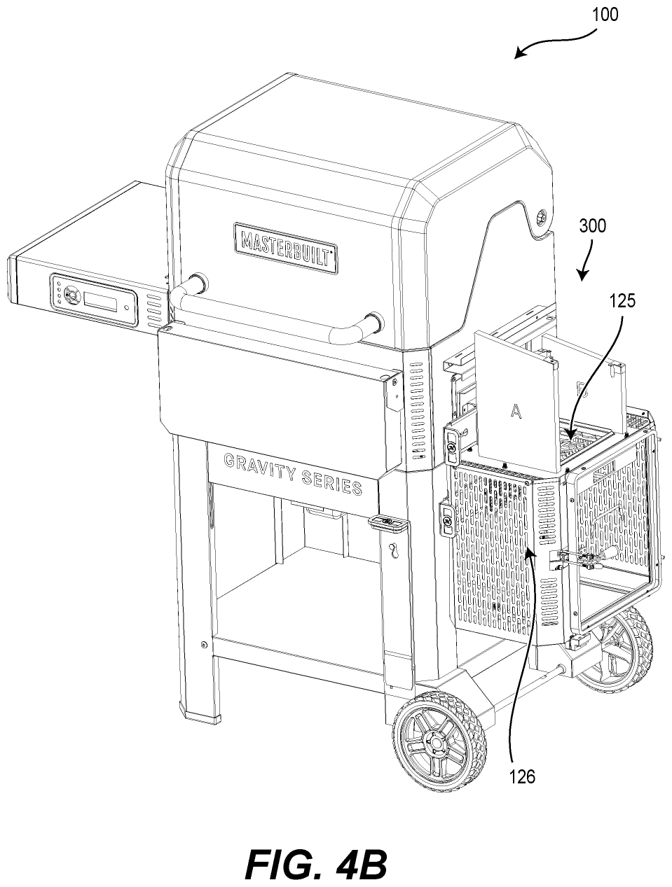

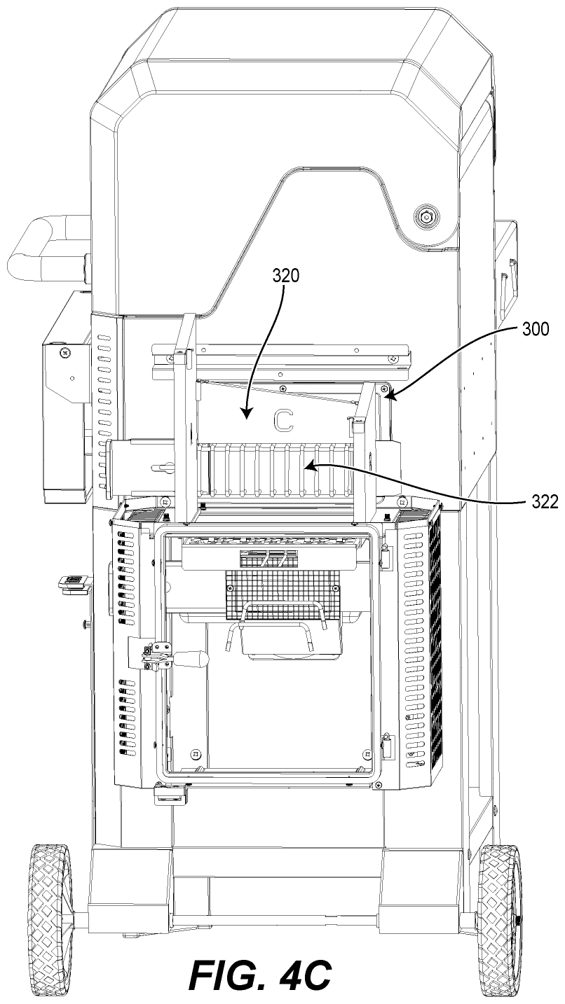

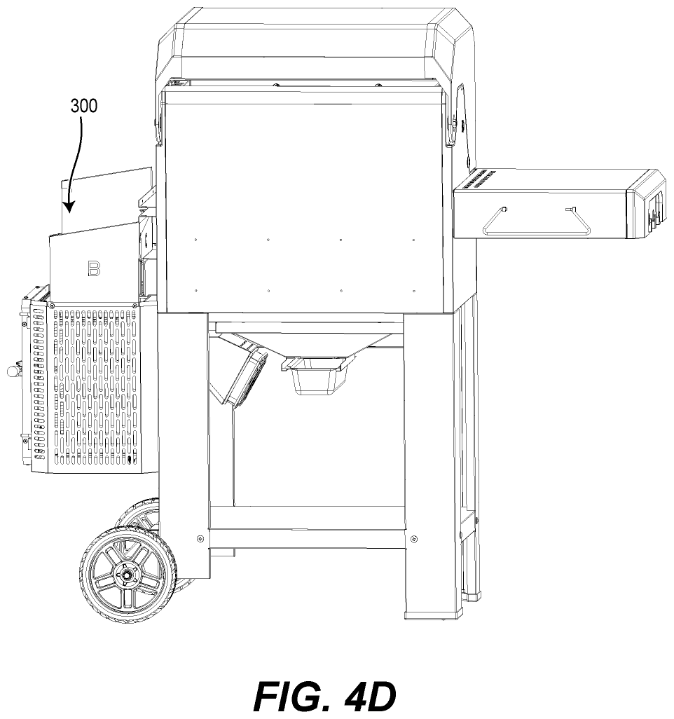

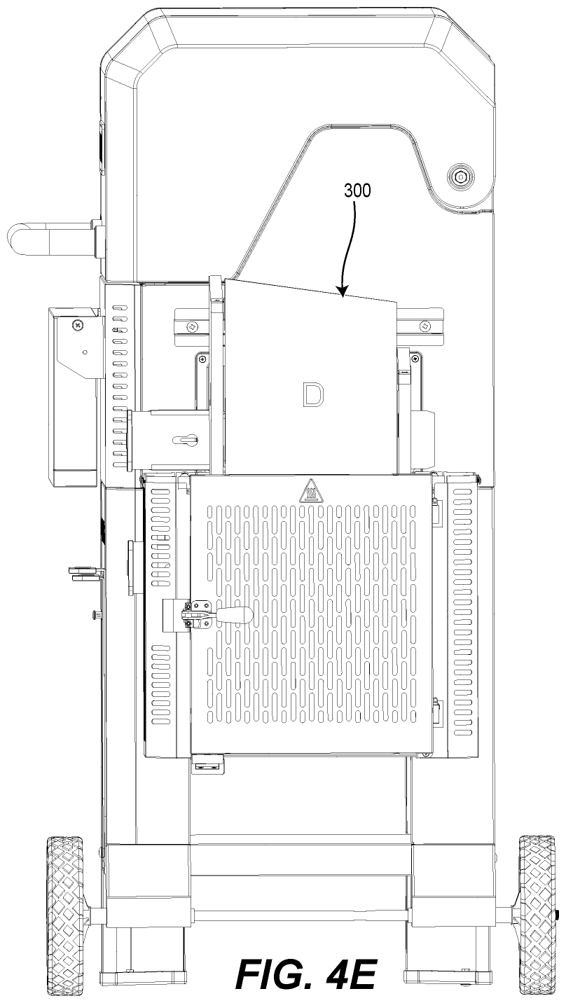

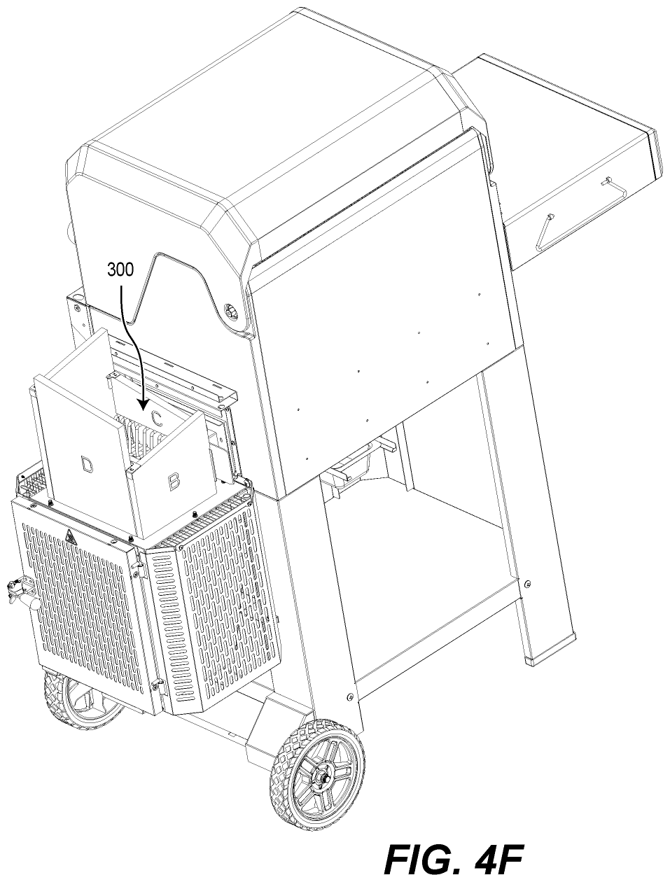

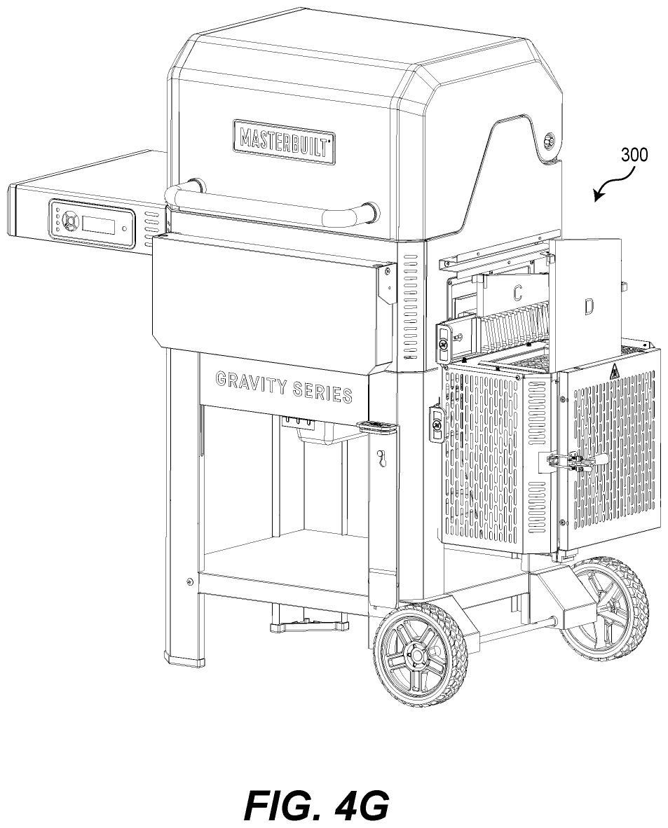

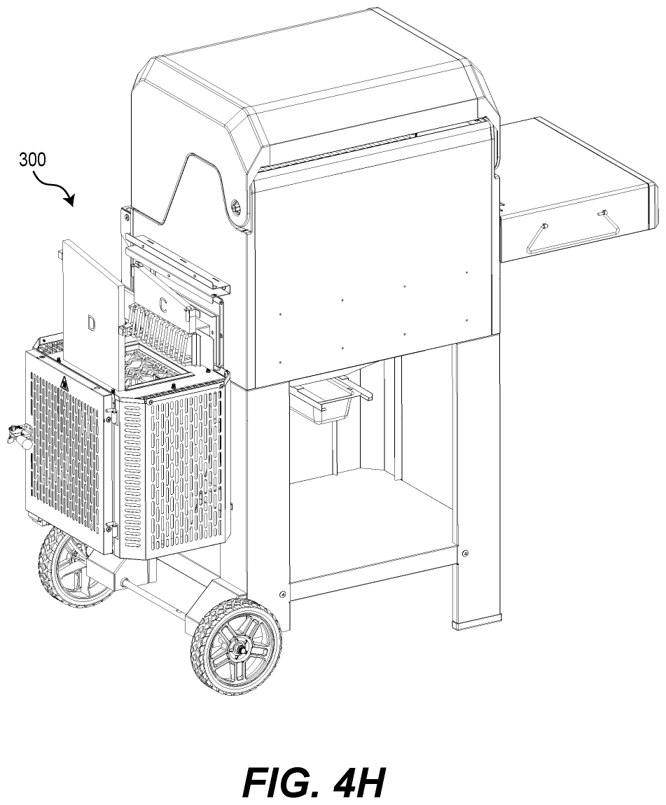

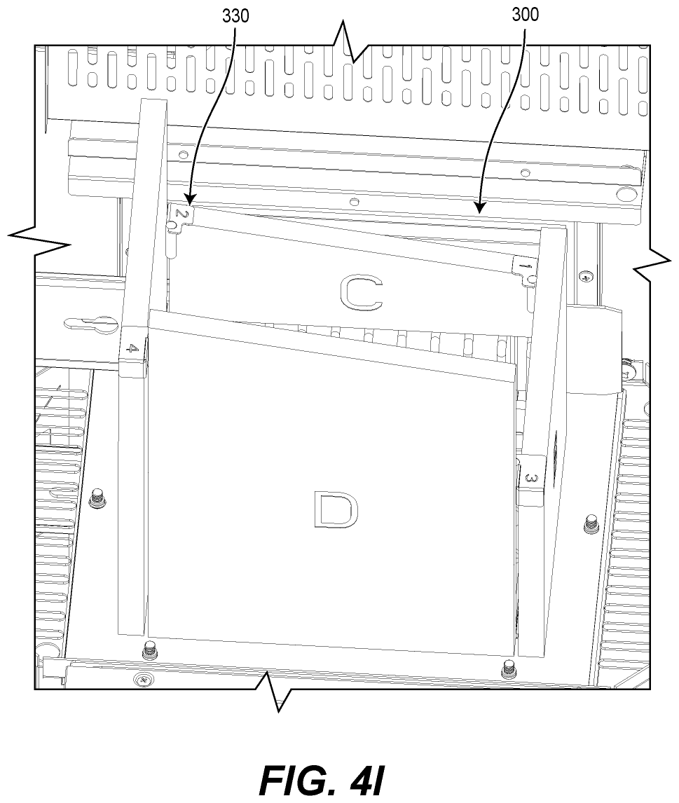

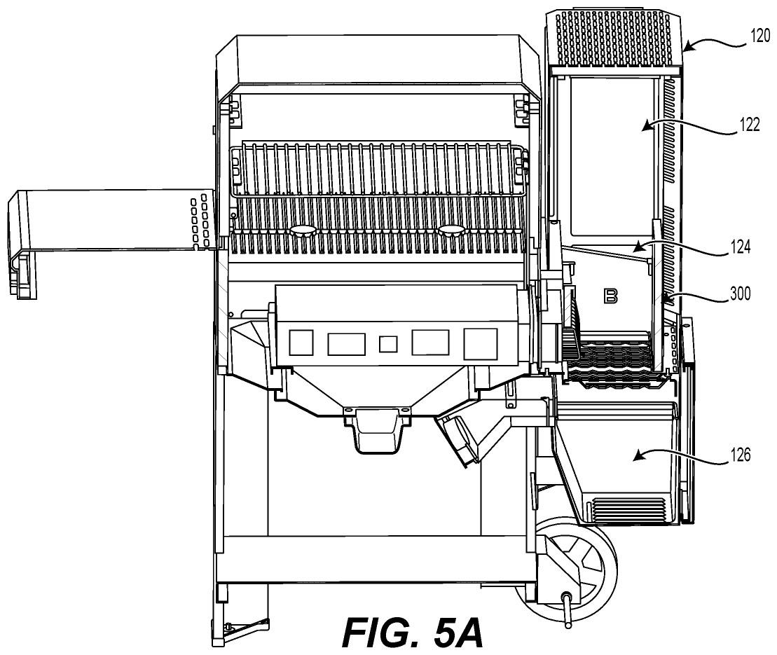

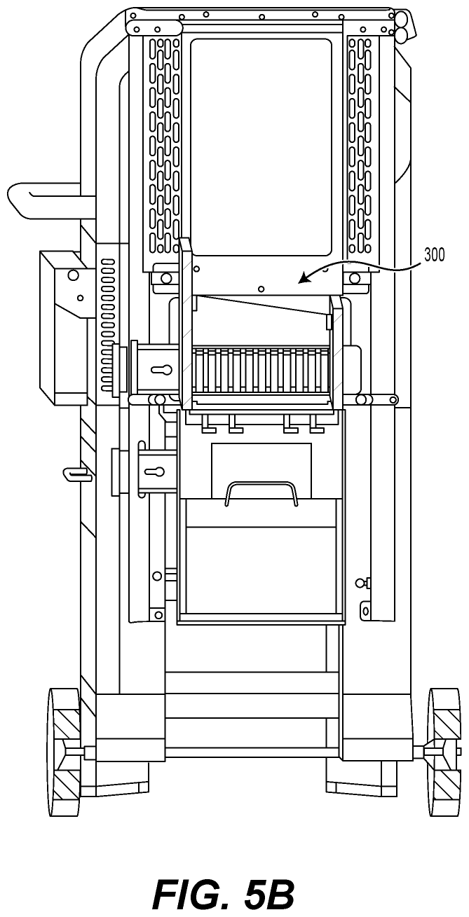

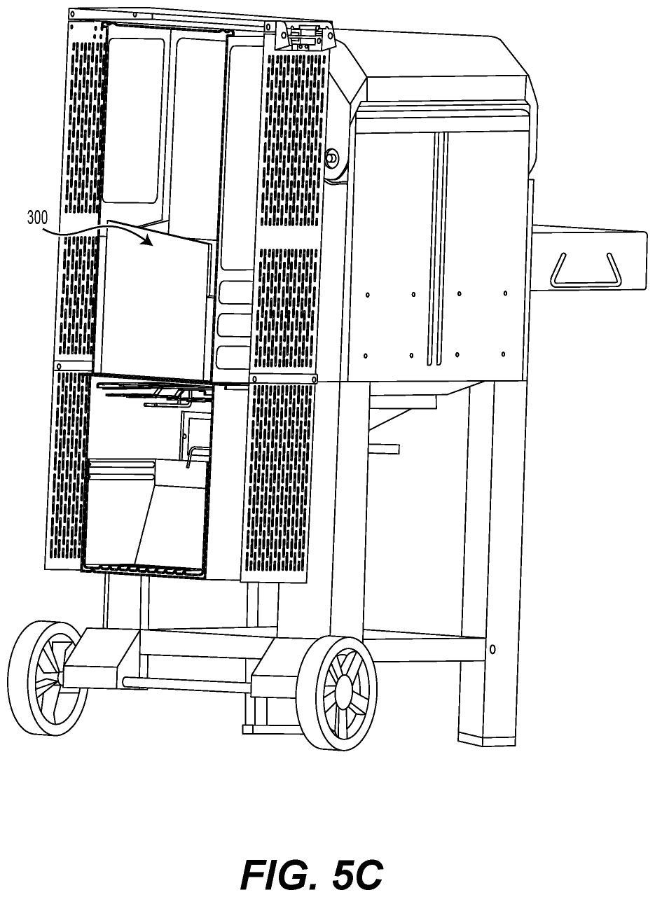

FIGS. 4A-4I show various views of how the refractory insert 300 may be used in certain exemplary embodiments using the exemplary grill and smoker 100 in FIGS. 1A-1C. Further, FIGS. 5A-5C are cross-sectional views of the grill and smoker 100 including the refractory insert 300 and further show the positioning of the refractory insert 300 relative to other components of the grill and smoker 100. As illustrated in FIGS. 4A-5A, the refractory insert 300 may be positioned above the lower stack portion 126 and within the firebox 124. The refractory insert 300 preferably lines the inner walls (or at least portions thereof) of the firebox 124 and is preferably positioned above the firebox grate 125. In some exemplary embodiments, for instance as FIG. 4I illustrates, the walls of the refractory insert (310A, 310B, 310C, and 310D) may be coupled together via one or more brackets 330 (shown with numbers 1, 2, 3, and 4).

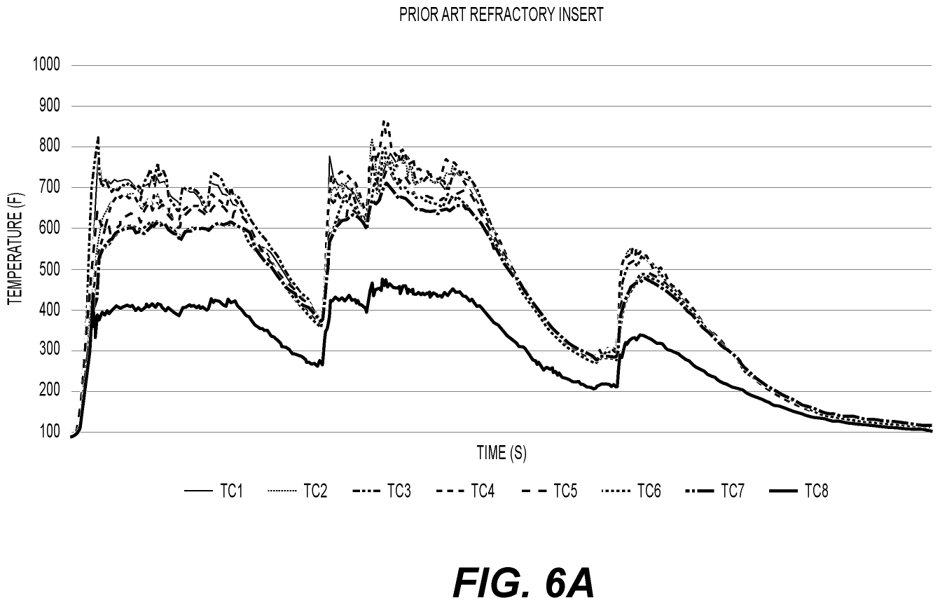

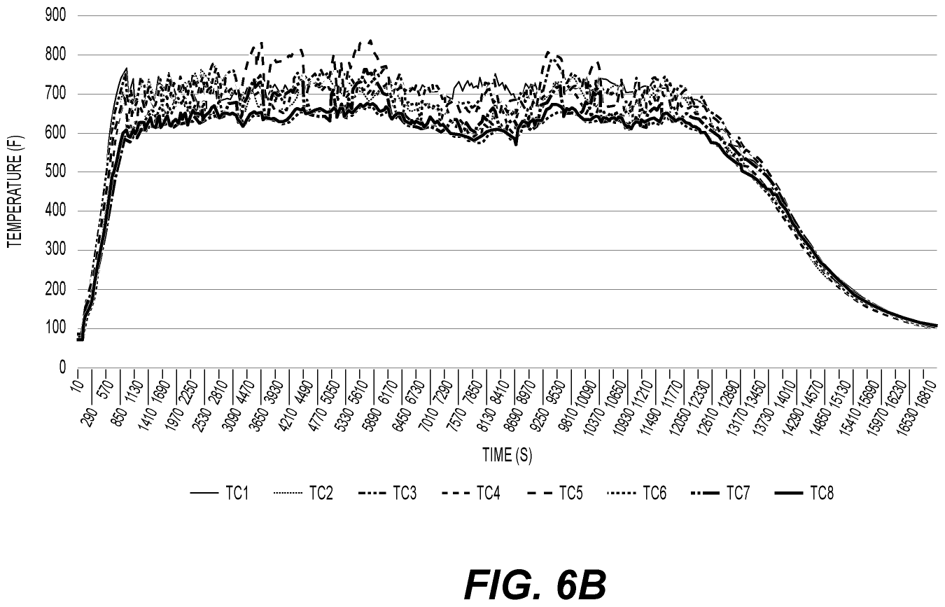

FIGS. 6A and 6B are exemplary graphical representations showing measurements of temperature with respect to time when a refractory insert is used in a grill and smoker (such as that illustrated in FIGS. 1A-1C). FIG. 6A illustrates temperature with respect to time using the prior-art refractory insert configuration disclosed in FIG. 2 with measurements at different locations throughout the grill (TC1-TC8). FIG. 6B illustrates temperature with respect to time for an exemplary embodiment of the inventive refractory insert 300, such as disclosed in FIG. 3A-3C.

In both test scenarios, the feed hopper of the grill and smoker (such as the grill and smoker shown in FIGS. 1A-1C) was filled with equal weights and sizing of lump charcoal. The lump charcoal was then lit and allowed to burn until all the charcoal was burned out. The grill temperature was set 700° F. during the test. Temperature measurement devices were placed in different locations within the cooking chamber of the grill and smoker (labeled as TC1-TC8 in FIG. 6A and 6B and shown as different lines on the graphical representation).

The graphs shown in FIG. 6A are a representation of temperature in the cooking chamber (measured in Fahrenheit and displayed on the y-axis) over time (measured in seconds). The valleys shown in FIG. 6A represent dips in temperature within the cooking chamber at different points in time believed to be due to bridging of the solid fuel across the horizontal top edges of the prior-art refractory insert in FIG. 2. FIG. 6B shows significantly reduced decreases in temperature due to the improved refractory insert 300 design and configuration, indicating that the temperature remained steadier throughout the tests performed to obtain the data in this graph.

The foregoing description has been directed to specific exemplary embodiments. It will be apparent, however, that other variations and modifications may be made to the described embodiments, with the attainment of some or all of their advantages. For example, those skilled in the art will recognize that the refractory insert described in the exemplary disclosed embodiments may be used in various types of grills and smokers to avoid bridging of fuel pieces in the grill or smoker consistent with the descriptions in the disclosed embodiments herein. Accordingly, this description is to be taken only by way of example and not to otherwise limit the scope of the embodiments herein.

I claim:

1. A refractory insert for use in a fuel-combusting area comprising:
a first set of opposing walls comprising:
a first wall comprising a first height; and
a second wall comprising a second height and positioned in the refractory insert such that an inner surface of the second wall at least partially faces an inner surface of the first wall, wherein the first height is different from the second height; and
wherein a top edge of at least one of the first wall or second wall is sloped.

2. The refractory insert of claim 1, wherein the top edge of the at least one wall of the first wall or second wall is sloped at an angle of from 5 degrees to 20 degrees.

3. The refractory insert of claim 2, wherein the top edge of the at least one wall of the first wall or second wall is sloped at an angle of from 8 degrees to 9 degrees.

4. The refractory insert of claim 1, further comprising a second set of opposing walls comprising:
a third wall comprising a third height; and
a fourth wall comprising a fourth height and positioned in the refractory insert such that an inner surface of the fourth wall at least partially faces an inner surface of the third wall;
wherein the third height is different from the fourth height; and
wherein a top edge of at least one wall of the second set of opposing walls is sloped.

5. The refractory insert of claim 4, wherein each of the first set of opposing walls and the second set of opposing walls is configured to be positioned within the fuel-combusting area.

6. The refractory insert of claim 5, wherein an outer surface of one or more of the first wall, second wall, third wall, and fourth wall is positioned flush with an inner surface of the fuel-combusting area.

7. The refractory insert of claim 6, wherein the fuel-combusting area is a firebox of a grill and smoker.

8. The refractory insert of claim 4, wherein the first height, the second height, the third height, and the fourth height are each measured along a vertical midline of the respective first wall, second wall, third wall, and fourth wall.

9. The refractory insert of claim 4, wherein the first height, the second height, the third height, and the fourth height are each measured along a vertical edge of the respective first wall, second wall, third wall, and fourth wall.

10. The refractory insert of claim 4, wherein the top edge of the at least one wall of the second set of opposing walls is sloped at an angle of from 5 degrees to 20 degrees.

11. The refractory insert of claim 10, wherein the top edge of the at least one wall of the second set of opposing walls is sloped at an angle of from 8 degrees to 9 degrees.

12. The refractory insert of claim 4, wherein the first set of opposing walls are coupled with the second set of opposing walls.

13. The refractory insert of claim 12, wherein the first set of opposing walls and the second set of opposing walls are coupled together via a bracket and a fastener positioned on a corner of a top edge of one or more of the opposing walls.

14. The refractory insert of claim 4 wherein each of the first wall, second wall, third wall, and fourth wall are each at least partially composed of a refractory material.

15. The refractory insert of claim 14, wherein the refractory material comprises one or more of a ceramic, a ceramic composite, fire brick, a metal.

16. A cooking apparatus comprising:
a fuel-combusting area; and
a refractory insert positioned within the fuel-combusting area, the refractory insert comprising:
a first set of opposing walls, wherein a first wall of the first set of opposing walls comprises a first height and a second wall of the first set of opposing walls comprises a second height, wherein the first height is different from the second height; and
wherein a top edge of at least one wall of the first set of opposing walls is sloped.

17. The cooking apparatus of claim 16, wherein the top edge of the at least one wall of the first set of opposing walls of the refractory insert is sloped at an angle of from 5 degrees to 20 degrees.

18. The cooking apparatus of claim 16, wherein the top edge of the at least one wall of the second set of opposing walls of the refractory insert is sloped at an angle of from 8 degrees to 9 degrees.

19. The cooking apparatus of claim 16, wherein the refractory insert further comprises a second set of opposing walls comprising:
a third wall comprising a third height; and
a fourth wall comprising a fourth height and is positioned in the refractory insert such that an inner surface of the fourth wall at least partially faces an inner surface of the third wall;
wherein the third height is different from the fourth height; and
wherein a top edge of at least one wall of the second set of opposing walls is sloped.

20. The cooking apparatus of claim 19, wherein an outer surface of one or more of the first wall, second wall, third wall, and fourth wall are flush with an inner surface of the fuel-combusting area.

21. The cooking apparatus of claim 19, where the cooking apparatus further comprises at least one grate and wherein a bottom edge of at least one of the first wall, second wall, third wall, and fourth wall is positioned on a surface of the grate.

22. The cooking apparatus of claim 19, wherein the first height, the second height, the third height, and the fourth height are measured along a vertical midline of the respective first wall, second wall, third wall, and fourth wall of the refractory insert.

23. The cooking apparatus of claim 19, wherein the first height, the second height, the third height, and the fourth height are measured along a vertical edge of the respective first wall, second wall, third wall, and fourth wall of the refractory insert.

24. The cooking apparatus of claim 19, wherein the top edge of the at least one wall of the second set of opposing walls of the refractory insert is sloped at an angle of from 5 degrees to 20 degrees.

25. The cooking apparatus of claim 24, wherein the top edge of the at least one wall of the second set of opposing walls of the refractory insert is sloped at an angle of from 8 degrees to 9 degrees.

26. The cooking apparatus of claim 19, wherein the first set of opposing walls are coupled with the second set of opposing walls.

27. The cooking apparatus of claim 19, wherein the first set of opposing walls and the second set of opposing walls are coupled together via a bracket and a fastener positioned on a corner of a top edge of one or more of the opposing walls.

28. The cooking apparatus of claim 16, wherein the cooking apparatus is a grill and smoker configured to gravity feed fuel into the fire box.

29. A refractory insert for use in a fuel-combusting area comprising:
a first set of opposing walls comprising:
a first wall comprising a first height; and
a second wall comprising a second height and positioned in the refractory insert such that an inner surface of the second wall at least partially faces an inner surface of the first wall; and
wherein the first height is different from the second height.

30. A cooking apparatus comprising:
a fuel-combusting area; and
a refractory insert positioned within the fuel-combusting area, the refractory insert comprising:
a first set of opposing walls, wherein a first wall of the first set of opposing walls comprises a first height and a second wall of the first set of opposing walls comprises a second height; and
wherein the first height is different from the second height.
